(19) United States
(12) Patent Application Publication
(10) Pub. No.: US 2012/0131319 A1
(43) Pub. Date: May 24, 2012

(54) SECURITY PROTECTION SYSTEM AND METHOD

(75) Inventor: SHUANG PENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/170,171

(22) Filed: Jun. 27, 2011

(30) Foreign Application Priority Data
Nov. 24, 2010 (CN) 201010557454.0

(51) Int. Cl. G06F 9/32

(52) U.S. Cl. 713/2

(57) ABSTRACT

A server includes a baseboard management controller (BMC). The server receives a first password and a second password input by a user. The BMC stores a first cryptograph corresponding to the first password in a field-replaceable unit (FRU) of the BMC. If a second cryptograph corresponding to the second password is the same as the first cryptograph, the server is started up. If the second cryptograph is not the same as the first cryptograph and a number of times that the second password has been input is greater than a predefined number of times, the server is locked.

### BACKGROUND

1. Technical Field

Embodiments of the present disclosure generally relate to security management, and more particularly to a security protection system and method applied in a server.

2. Description of Related Art

To protect a computer from being logged into by other people, the computer can be protected by a password. The password is usually stored in a complementary metal oxide semiconductor (CMOS) by the basic input output system (BIOS) of the computer. If the computer encounters a sudden power failure, the password stored in the CMOS may be cleared, then other people may be able to log into the computer easily.

### BRIEF DESCRIPTION OF THE DRAWINGS

FIG. 1 is a block diagram of one embodiment of a server comprising a security system.

FIG. 2 is a block diagram of one embodiment of function modules of the security protection system in FIG. 1.

FIG. 3 is a block diagram of one embodiment of a flowchart illustrating a security protection method.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

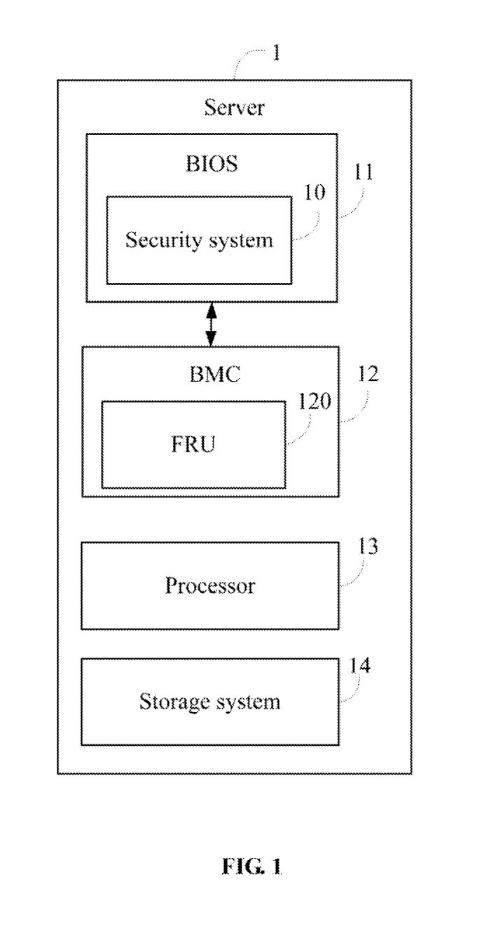

FIG. 1 is a block diagram of one embodiment of a server 1 comprising a security system 10. The server 1 includes a basic input output system (BIOS) 11 and a baseboard management controller (BMC) 12. The BIOS 11 provides an interface on a display for a user to set a password for the server 1. The BMC 12 includes a field-replaceable unit (FRU) 120. The FRU 120 stores a cryptograph of the password.

In an exemplary embodiment, the server 1 includes at least one processor 13 and a storage system 14. The security protection system 10 may include one or more modules. The one or more modules may comprise computerized code in the form of one or more programs that are stored in the storage system 14 (or memory). The computerized code includes instructions that are executed by the at least one processor 14 to provide functions for the one or more modules.

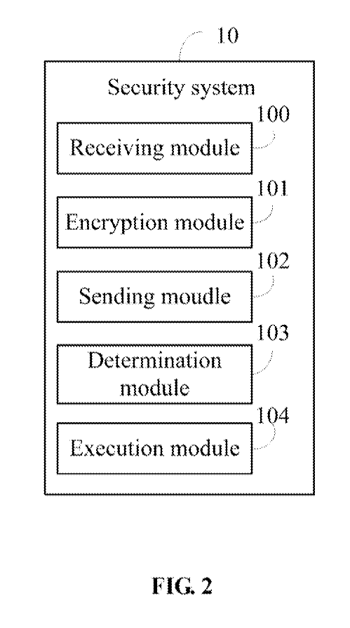

As shown in FIG. 2, the security protection system 10 may include a receiving module 100, an encryption module 101, a sending module 102, a determination module 103, and an execution module 104.

The receiving module 100 receives a first password set by the user. In one embodiment, the user sets the first password through the interface provided by the BIOS 12. The first password may be in plain text.

The encryption module 101 generates a first cryptograph corresponding to the first password.

The sending module 102 sends a storing command to the BMC 12. The BMC 12 stores the first cryptograph in the FRU 120 according to the storing command.

The receiving module 100 also receives a second password input by the user after the BIOS 11 has been initialized. For example, when the user intends to log in to the server 1, a dialog box may pop up to prompt the user to input the second password.

The encryption module 101 further generates a second cryptograph corresponding to the second password.

The sending module 102 sends a reading command to the BMC 12. The BMC 12 reads the first cryptograph from the FRU 120 according to the reading command.

The determination module 103 determines if the second cryptograph is the same as the first cryptograph.

If the second cryptograph is not the same as the first cryptograph, the determination module 103 further determines if a number of times that the second password was input is greater than a predefined number of times. In one embodiment, the predefined number of times is three. If the number of times that the second password was input is greater than the predefined number of times, the execution module 104 locks the server 1. If the server 1 is locked, the server is shut down. If the number of times that the second password has been input is not greater than the predefined number of times, the execution module 104 further prompts the user to input the second password one more time.

If the second cryptograph is the same as the first cryptograph, the execution module 104 starts up the server 1.

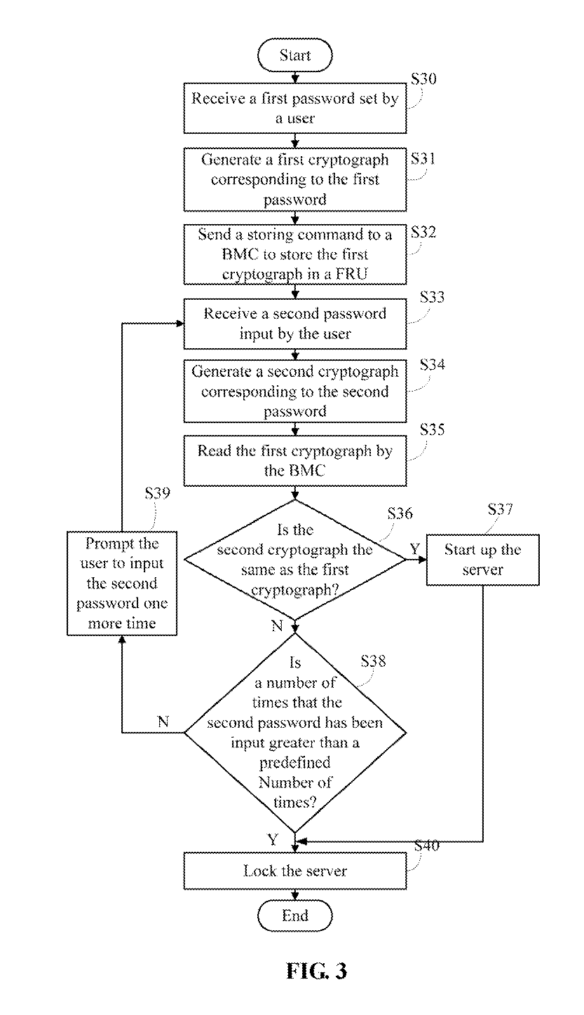

FIG. 3 is a flowchart illustrating a method for protecting passwords. Depending on the embodiment, additional blocks may be added, others removed, and the ordering of the blocks may be changed.

In block S30, the receiving module 100 receives a first password set by the user.

In block S31, the encryption module 101 generates a first cryptograph corresponding to the first password.

In block S32, the sending module 102 sends a storing command to the BMC 12. The BMC 12 stores the first cryptograph in the FRU 120 according to the storing command.

In block S33, the receiving module 100 receives a second password input by the user after the BIOS 11 has been initialized.

In block S34, the encryption module 101 generates a second cryptograph corresponding to the second password.

In block S35, the sending module 102 sends a reading command to the BMC 12. The BMC 12 reads the first cryptograph from the FRU 120 according to the reading command.

In block S36, the determination module 103 determines if the second cryptograph is the same as the first cryptograph. If the second cryptograph is the same as the first cryptograph, block S37 is implemented. If the second cryptograph is not the same as the first cryptograph, block S38 is implemented.

In block S37, the execution module 104 starts up the server 1 and the procedure ends.

In block S38, the determination module 103 detects if the number of times that the second password has been input is greater than a predefined number of times. If the number of times that the second password has been input is greater than the predefined number of times, block S40 is implemented. If the number of times the second password has been input is not greater than the predefined number of times, block S39 is implemented.

In block S39, the execution module 104 prompts the user to input the second password one more time, and block S33 to block S38 are repeated.

In block S40, the execution module 104 locks the server 1.

Although certain embodiments of the present disclosure have been specifically described, the present disclosure is not to be construed as being limited thereto. Various changes or modifications may be made to the present disclosure beyond departing from the scope and spirit of the present disclosure.

What is claimed is:

1. A server, comprising:
a storage system;
at least one processor; and
one or more programs being stored in the storage system and executable by the at least one processor, the one or more programs comprising:
a receiving module operable to receive a first password set by a user and a second password input by the user;
an encryption module operable to generate a first cryptograph corresponding to the first password, and generate a second cryptograph corresponding to the second password;
a sending module operable to send a reading command to a baseboard management controller (BMC) to inform the BMC to read the first cryptograph;
a determination module operable to determine if the second cryptograph is the same as the first cryptograph; and
an execution module operable to start up the server if the second cryptograph is the same as the first cryptograph, or prompt the user to input the second password one more time if the second cryptograph is not the same as the first cryptograph and a number of times that the second password has been input is not greater than a predefined number of times.

2. The server as described in claim 1, wherein the server provides an interface for the user to input the first password and the second password.

3. The server as described in claim 1, wherein the sending module is further operable to send a storing module to the BMC to inform the BMC to store the first cryptograph in a field-replaceable unit (FRU) of the BMC.

4. The server as described in claim 1, wherein the execution module is further operable to lock the server if the second cryptograph is not the same as the first cryptograph and the number of times that the second password has been input is greater than the predefined number of times.

5. A security protection method, comprising:
(a) receiving a first password and generating a first cryptograph corresponding to the first password;
(b) receiving a second password and generating a second cryptograph corresponding to the second password;
(c) sending a reading command to a baseboard management controller (BMC) to inform the BMC to read the first cryptograph;
(d) determining if the second cryptograph is the same as the first cryptograph, implementing block (e) if the second cryptograph is the same as the first cryptograph, and implementing block (f) if the second cryptograph is not the same as the first cryptograph; and
(e) starting up the server, and ending the procedure; and
(f) prompt the user to input the second password one more time if a number of times that the second password has been input is not greater than a predefined number of times, and returning to block (b).

6. The method as described in claim 5, wherein the server provides an interface for the user to input the first password and the second password.

7. The method as described in claim 5, after block (a) comprising:
sending a storing command to the BMC to inform the BMC to store the first cryptograph in a field-replaceable unit (FRU) of the BMC.

8. The method as described in claim 5, further comprising:
locking the server if the second cryptograph is not the same as the first cryptograph and the number of times that the second password has been input is greater than the predefined number of times.

9. A non-transitory storage medium having stored thereon instructions that, when executed by a processor, cause the processor to perform a security protection method, the method comprising:
(a) receiving a first password and generating a first cryptograph corresponding to the first password;
(b) receiving a second password and generating a second cryptograph corresponding to the second password;
(c) sending a reading command to a baseboard management controller (BMC) to inform the BMC to read the first cryptograph;
(d) determining if the second cryptograph is the same as the first cryptograph, implementing block (e) if the second cryptograph is the same as the first cryptograph, and implementing block (f) if the second cryptograph is not the same as the first cryptograph; and
(e) starting up the server, and ending procedure; and
(f) prompt the user to input the second password one more time if a number of times that the second password has been input is not greater than a predefined number of times, and returning to block (b).

10. The non-transitory storage medium as described in claim 9, wherein the server provides an interface for the user to input the first password and the second password.

11. The non-transitory storage medium as described in claim 9, after block (a) comprising:
sending a storing command to the BMC to inform the BMC to store the first cryptograph in a field-replaceable unit (FRU) of the BMC.

12. The non-transitory storage medium as described in claim 9, further comprising:
locking the server if the second cryptograph is not the same as the first cryptograph and the number of times that the second password has been input is greater than the predefined number of times.
